(19) United States
(12) Patent Application Publication
(10) Pub. No.: US 2001/0042079 A1
(43) Pub. Date: Nov. 15, 2001

(54) Display control with active hypertext documents

(76) Inventor: Patrick Urban, Paderborn (DE)

Correspondence Address: HARNESS, DICKEY & PIERCE, PLC, P.O. BOX 828, BLOOMFIELD HILLS, MI, 48303, US

(21) Appl. No.: 09/827,518

(22) Filed: Apr. 6, 2001

(30) Foreign Application Priority Data
May 9, 2000 (DE) 100 22 318.4

(51) Int. Cl. G06F 17/21

(52) U.S. Cl. 707/501.1

(57) ABSTRACT

Computer application having a sequence controller and a user interface, the user interface being produced by showing pages of a markup language, and at least part of the sequence controller being produced by programs which can be embedded in pages of this markup language, and the page containing the sequence controller and the page to be displayed which produces the user interface are separate from one another.

### TECHNICAL FIELD

The invention relates to sequence control for computer programs, in particular in the case of active hypertext documents, i.e. those involving execution of programs on the computer displaying the document.

### PRIOR ART

In one application of data processing, a distinction is drawn between the processing logic, i.e. the actual program, and the interaction with the user via a user interface, usually given this name, UI, or called a graphical user interface, (GUI). A known example is the GUI of the Windows operating systems, which is integrated into the executable program via interface calls. In this case, it is not possible to separate the processing logic from the user interface calls. That is to say the processing logic and the structure of the interface are integrally combined with one another.

In quite a few application instances, however, it is desirable for the user interface and the processing logic to be separated. This starts with the creation of language-specific variants and ends with a different design for the screen displays. In particular, this has resulted in the creation of highly complex development systems, such as Delphi from the company Inprise, which uses object-oriented programming to produce the sequence controller and uses an interactive formatting program to produce the user interface. Although this allows a change to be made much more quickly, the programmer needs to understand the development environment fully so that no unwanted changes are made. Another approach to achieving this object is to use a standardized display program and to set up the screen display using a hypertext markup language, such as HTML. HTML allows the definition of input fields into which data can be entered by the user, sent to a server via a network and processed there. Processing then takes place exclusively in the server, however, in particular using programs which are called on the basis of the common gateway interface, (CGI), and return a new HTML page as the result of the programmed sequence.

However, since the HTML pages are produced by the CGI program, the program and the user interface are again mixed. This solution has the additional disadvantage that it runs completely on the server.

Expansions of HTML have therefore been described using the keyword “active contents”, said expansions permitting program execution on the system displaying the HTML page. These expansions are known by the (brand) names JAVASCRIPT, JAVA and ActiveX. In the case of JAVASCRIPT the instructions for the programs are embedded in the page, and, in the case of JAVA, are transmitted as a separate precompiled file (byte code). As before, there is a close link between program and representation by HTML, however. Since, in addition, the program parts are limited to one HTML page each, problems arise with regard to program organization if it is necessary to control complex transaction applications, as arise in the case of cash machines etc.

The object of the invention is therefore to specify a solution in which the user interface is decoupled from the execution logic and a standardized markup language such as HTML can still be used.

### SUMMARY OF THE INVENTION

The solution comprises a series of steps which can each be used independently and are particularly advantageous in their entirety. Hence, the invention is described below on the basis of a simple process with the aid of the changes or supplements which can be applied to it in each case. The code examples used in this context are highly simplified to assist clarity, and possibly also perform functions for which integrated means are available.

### BRIEF DESCRIPTION OF THE FIGURES

FIG. 1 is a computer network diagram with associated software block diagram, illustrating a presently preferred embodiment of the invention;

FIG. 2 is a detailed block diagram of the software architecture of a presently preferred embodiment, illustrating exemplary content, event handling mechanisms and messages that correspond to the code listings 1-4 (“Listings”) appearing at the end of the specification.

### DESCRIPTION OF AN EMBODIMENT OF THE INVENTION

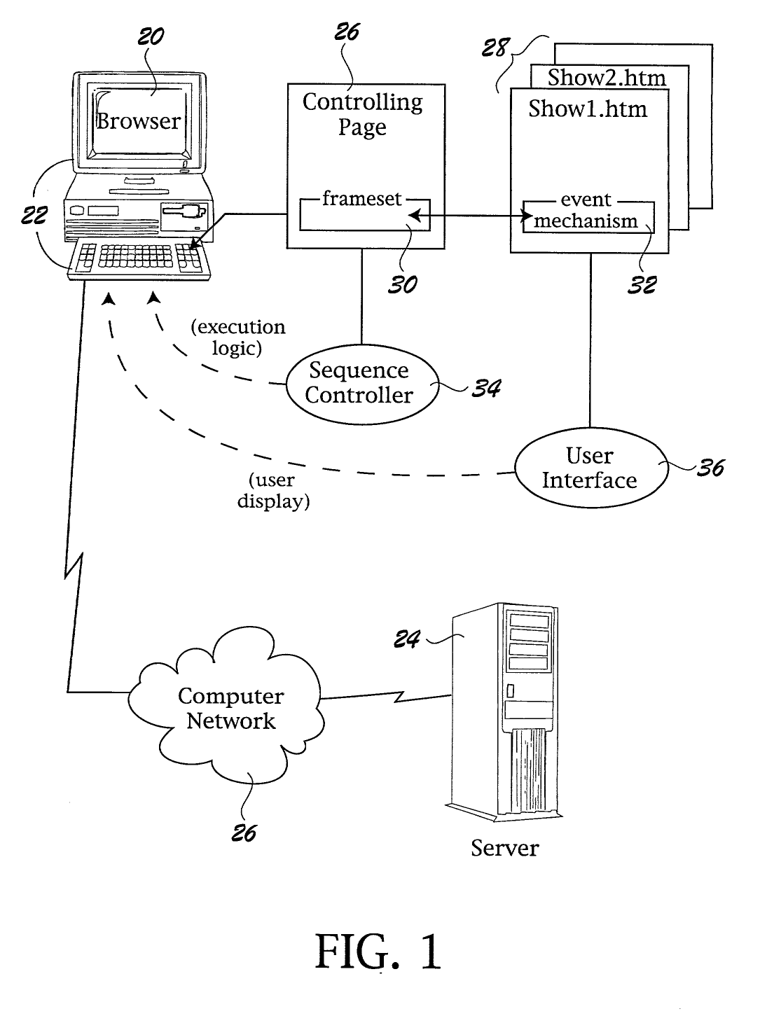

The display control method and apparatus of the invention may be implemented to run in a browser environment. FIG. 1 illustrates a browser 20 running as an application program or operating system component on a computer 22. The browser is configured in the conventional fashion to display web pages based on HTML code sent from a server 24 over a suitable computer network 26, such as the Internet.

In accordance with the invention, the browser 20 is supplied with HTML data corresponding to a controlling page 26 and to one or more displayed show pages 28. As will be more fully explained below, the controlling page includes a frameset 30 that contains the HTML code corresponding to a displayed one of the show pages 28. Where user interactivity is desired, the displayed show page 28 contains an event handling mechanism 32 that sends event messages back to the controlling page, which responds to those event messages by causing certain executable steps to be performed. Thus the controlling page 26 provides sequence controller functionality, illustrated diagrammatically at 34 while the show pages 28 provide user interface functionality, shown diagrammatically at 36. The sequence controller functionality provides execution logic to the computer 22 while the user interface 36 provides the user display seen in browser 20.

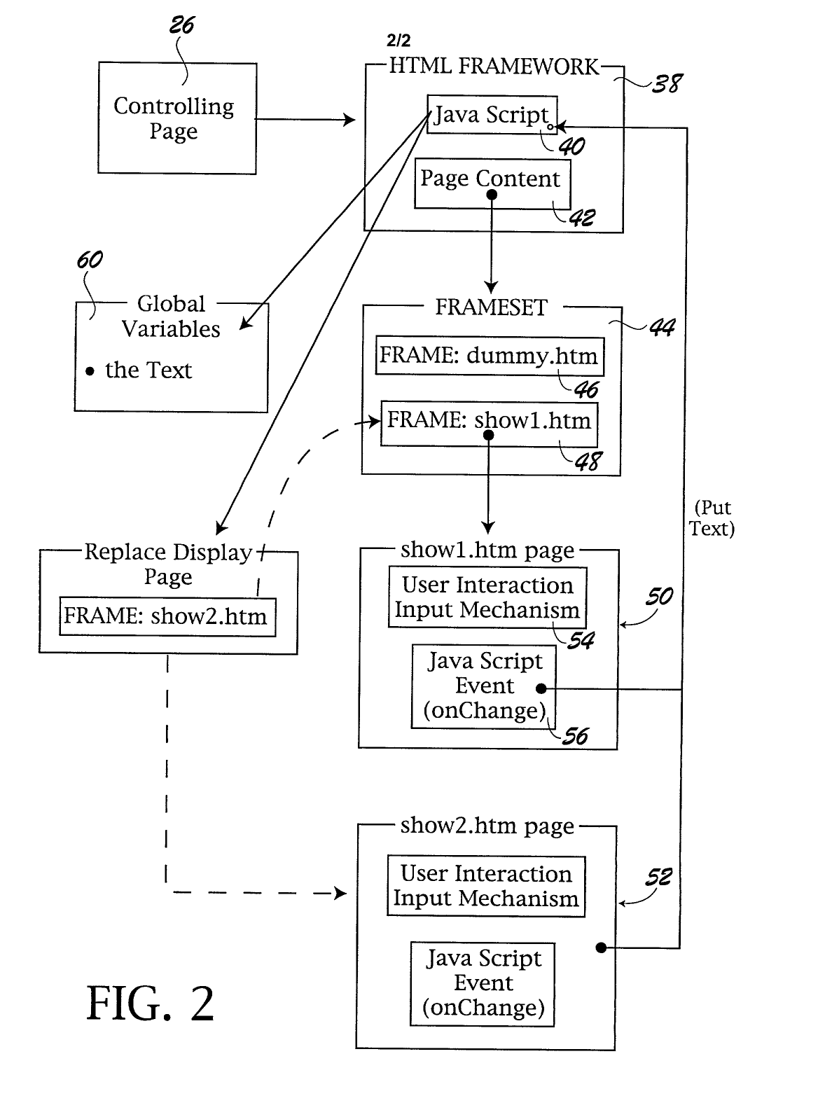

FIG. 2 shows the presently preferred software system architecture in greater detail. The controlling page 26 contains computer code suitable for utilization by the browser 20. A presently preferred embodiment uses HTML code with embedded JavaScript. Other forms of executable code, including JAVA and ActiveX, may be used. Other markup languages, such as XML may likewise be used in place of HTML.

The controlling page 26, when implemented using HTML, includes an HTML framework 38. The details of the controlling page are shown in listing 1, described more fully below. The HTML framework 38 encloses the executable code, such as JavaScript 40 and also a frameset for containing the page content 42. In FIG. 2 the frameset has been illustrated as a separate entity, frameset 44, for illustration purposes.

Frameset 44 may include one or more frames containing show pages or other data. In FIG. 2 frameset 44 is illustrated with two frames, a dummy show page 46 and a first displayed show page 48. The first displayed show page is also identified in FIG. 2, and in the code listings, as “show1.htm.”

The general layout for two exemplary show pages (show1.htm and show2.htm) are shown broken out at 50 and 52. The show1.htm page 50 is currently loaded or referenced as show page 48. The show1.htm page includes a user interaction input mechanism 54 and an event monitoring mechanism 56. The event monitoring mechanism sends event messages to the JavaScript 40, causing it to perform certain execution logic.

When the user loads the controlling page 26 in browser 20, the page content information within frameset 44 determines what the user will see in the user interface. The specific example illustrated in FIG. 2 corresponds to the code listings below. As more fully discussed in reference to those code listings, the first loaded page, “dummy.htm” 46 is effectively an empty header containing no variable data. It is illustrated here simply to show that the frameset can contain page information that does not provide any active content. The second loaded page “show1.htm” 48 generates the current user display. For purposes of this example, the user interaction input mechanism 54 of the show1.htm page is a message or prompt to the user “Please Enter Text.” Below the prompt is an input field into which the user can type text that the user desires to input. Of course, this is merely one example. There are many different types of user interaction input mechanisms available under current web technology. These include, dropdown list boxes, check boxes, radio buttons, active regions and the like.

The event monitoring mechanism 56 of the show1.htm page is an “onchange” JavaScript command in the present example. The “onchange” command monitors the input field generated by the user interaction input mechanism. When the JavaScript detects a change event (such as, when the user types text into the field) the event handler mechanism sends an event message to the JavaScript 40. In this example, the event message is a “putText” command that is sent back to the JavaScript 40 of the controlling page 26. It bears noting that the “onChange” event command and the “putText” event message are merely examples, suitable for capturing text input from the user. Any event detection mechanisms and event messages available in the executable scripting language may be used to effect the desired results.

Upon receipt of the “putText” message, the JavaScript 40 performs the sequence of execution logic coded for that input message. In this example, the script first writes the user's input into a global variable space 60 as the global variable “theText.” Then the script performs a display page replacement. Specifically, it loads show2.htm 52 in the location within frameset 44 previously occupied by the show1.htm page 50. By substituting a new show page for the originally displayed one, the user is presented with a different display that is dictated by the contents of show2.htm page 52. This new content could include the same user interaction mechanism employed in the show1.htm page, or another user interaction input mechanism. The JavaScript event may be the same “onchange” event, with the same “putText” event message as used before. Alternatively, a different and/or event message can be used.

While the show pages employed thus far have permitted user interaction, it is also possible to load pages into frameset 44 that do not allow user interaction or display active content. The choice of what to display and what interaction to permit will depend on the purpose of the web site being constructed using this technology. With the foregoing overview in mind, reference will now be made to the code listings 1-4 appearing at the end of this specification. Code listing 1 shows the code for the controlling page 26 featured in FIGS. 1 and 2. Listings 2 and 3 show exemplary code for the first display screen (show1.htm) and second display screen (show2.htm). Listing 4 shows exemplary code for a display screen without variable contents.

Listings 1 to 3 show codes formulated in the language HTML, which may be familiar. The numbers placed before the lines serve merely for the purpose of better reference and are not part of the coded instructions. The examples relate to the display program Netscape Communicator 4.7, called “browser” below.

Listing 1 shows the code for the controlling page. Lines 1 and 17 are part of the framework prescribed in HTML. Lines 2 to 12 contain JAVASCRIPT commands defining three functions, in particular, which are described more precisely further below in the context of their use.

Lines 13 to 16 define the content of the page as a frameset, in this case with horizontal subdivision into two frames, the first of which has a height of 10 pixels and the second of which fills up the remainder. The definitions of the two frames can be found under “dummy.htm” and “show1.htm” and are shown in Listing 4 and Listing 2. Provided that the browser so permits, preferably only one frame within the frameset is used, with the result that the “dummy.htm” frame, which is effectively empty and contains no kind of variable data, can be dispensed with.

Listing 2 shows the HTML text “show1.htm” loaded into the frame in which interaction with the user takes place. In this simple example, this merely comprises the prompt “Please Enter Text” in the second line and an input field in line 4, the “onchange” parameter in line 5 defining JAVASCRIPT event handling for said input field. This stipulates that the “puttext” function defined in line 4 of Listing 1 be called using the content of the “this.value” input field when the field content is changed. Depending on the browser, this function occurs when the TAB key or the ENTER key is used to leave the field, possibly depending on the further content of the page.

This “putText” function first stores the text submitted as parameter “x” in the global variable “theText” in line 5 of Listing 1. After a check in line 6 to determine whether the text is not empty, the frame's displayed screen, which has up to now been defined by “show1.htm”, is then replaced by “show2.htm” in line 7, in accordance with the invention. The result of this is thus that there is no sequence controller in the page which is defined by “show1.htm” and represents the user interface, but instead sequence control is effected by a function which is contained in another page, in this case in the page having the frameset, which again produces no kind of variable output visible to the user. In a realistic application, the functional body of the “putText” function, which in this case has been reduced to its essence for the sake of clarity, contains a complex sequence controller exhausting the possibilities of a programming language such as JAVASCRIPT.

Execution of line 5 in Listing 1 loads the HTML text shown in Listing 3 into the frame in which “show1.htm” has been active up to now. This screen comprises a prompt “Your Input: ” in line 4, a field “was” used for the output in line 5 and a button “Again” in line 6. The “onLoad” statement in line 2 calls the “getText” function, again from the superordinate frameset in Listing 1, in that case lines 8-9, and stores the result in the output field “was” in line 5 Listing 3. Once this HTML page has loaded, the previously entered text thus appears in the input field.

Pressing the “Again” button calls the “again” function from the frameset in Listing 1 lines 10-11, which in turn loads the first page “show1.htm” instead of the one displayed. In a realistic application, control will take place on the basis of complex program logic in this case too.

The result of this is that the sequence controller, which in this case minimally implements merely the change between two screen based on “show1.htm” and “show2.htm”, is stored exclusively in the HTML text shown in Listing 1.

Instead of using frames, as illustrated up to now, it is also possible to open a new window, e.g. using the script command “openWindow”. The Internet Explorer browser supports a “fullscreen” parameter for this, which makes the new window fill up the screen completely and thus cover the screen containing the controller, so that it is no longer visible to the user.

The application of the invention is particularly useful if local peripherals such as a magnetic card reader, a mouse or a keyboard are to be included, in the latter case also in special versions. In this case, handling is performed exclusively in the page containing the sequence controller.

Particularly if peripheral events such as keys being pressed or a magnetic card reader being activated by the insertion of a card need to be taken into account, the sequence controller can change the displays. This is possible using the “document object model” (DOM), which has already been used in the example. The page change effected in lines 7 and 11 by changing the “location” property of the “show” object as a subobject of “top” is one capability of the DOM. In the same way, the sequence controller can change the value of the field in line 5 of Listing 3 by assignment to “document.show.form1.was.value”. In this context, however, it should be taken into account that this is possible only when “show2.htm” is loaded completely, for which reason the solution in line 2 has been preferred in the present example for the sake of clarity. However, it is evident that it is also possible to dispense completely with active contents on the page representing the user interface.

The use of field names is compliant with a conventional interface. However, the pages producing the user interface preferably contain defined functions which change the fields and consequently hide the field names. This is more compliant with an object-oriented interface. In both cases, before calling the functions or reading or writing fields, the sequence controller will use the “typeof” operator to ensure that the object to be addressed is in fact present. This measure is supported if, during sequence control, the page uses the “onLoad” attribute of “<body>” to signal that interfaces are activated, and which interfaces are activated, and possibly also supplies references to the interface functions or data fields. This technique of recording functions and data fields is generally also known by the term “callback” and can be advantageously applied within the scope of the invention.

It should now be apparent that the data structures and corresponding executable code components are well-suited for delivery to a computer over a suitable computer network such as the Internet. The controlling page and associated show pages, structured in accordance with the foregoing, may be sent as packets of information over the computer network (e.g., computer network 26 of FIG. 1). These packets of information represent electronically embodied articles of manufacture when embedded in a suitable carrier wave to effect the transfer or propagation from server 24 to computer 22. It will, of course, be appreciated that these packets of information can be sent over any communications medium, including wire, broadband cable, fiberoptic cable, wireless broadcast, and the like.

CODE LISTING 1

1. <html><head><title>MAIN</title>

2. <script language=“javascript”>

3. var theText =“Initial Text”;

4. function puttext(x){

5. theText=x

6. if (theText!=″″){

7. top.show.location=“show2.htm”; }}

8. function getTexto{

9. return theText;}

10. function again( ){

11. - top.show.location=“show1.htm”; }

12. </script></head>

13. <frameset rows=“10,*”>

14. <frame name=dummy src=“dummy.htm”></frame>

15. <frame name=show src=“show1.htm”></frame>

16. </frameset>

17. </html>

CODE LISTING 2

1. <html><head><title>SHOW1</title></head>

2. <body>Please Enter Text: <br>

3. <form>

4. <INPUT type=“text” value=″″

5. onChange=“top.putText(this.value);”>

6. </form>

7. </body></html>

CODE LISTING 3

1. <html><head><title>SHOW2</title></head>

2. <body onLoad=“document.form1.was.value=top.getText( );”>

3. <form name=“form1”>

4. Your Input:

5. <input type=“Text” name=“was”>

6. <input type=“button” name=“Again” value=“Again”

7. onClick=“top.again( )”>

8. </form>

8. </body></html>

CODE LISTING 4

1. <html><head><title>DUMMY</title></head>

2. <body>DUMMY</body></html>

It is claimed:

1. A method for a computer application having a sequence controller and a user interface, the user interface being produced by showing pages of a markup language, and at least part of the sequence controller being produced by programs which can be embedded in pages of this markup language, characterized in that the page containing the sequence controller and the page to be displayed which produces the user interface are separate from one another.

2. The method as claimed in claim 1, where the sequence controller produces the display of one or more pages which are to be displayed.

3. The method as claimed in claim 1, where the page containing the sequence controller is not visible to the user.

4. The method as claimed in claim 1, where the page containing the sequence controller produces a display without variable contents.

5. The method as claimed in claim 1, where a display program for the markup language provides for the display area to be split into frames, and a frame without variable contents is used for the sequence controller page.

6. The method as claimed in claim 1, where the visual output is produced by means of the page which is to be displayed, and all the other peripheral devices, including keyboards or pointer devices, are controlled by the sequence controller.

7. The method as claimed in claim 1, where data is transferred between the sequence controller and the page to be displayed via a procedural or object-oriented interface.

8. A computer program which comprises the methods as claimed in claim 1.

9. A method of using a computer browser for interpreting user input through a user interface page that is separate from a sequence controller page comprising:
creating at least one user interface page with a markup language;
embedding executable code for an event handling mechanism in the user interface page;
displaying at least one user interface page;
creating a separate sequence controller page with a markup language;
embedding executable code for a sequence control program in the sequence controller page that will respond to event messages received through the displayed user interface page;
displaying at least one user interface page as a result of the event message received by the sequence control program; and
repeating the process of the sequence controller program in responding to event messages received through the displayed user interface page while event messages are received.

10. The method of claim 9 wherein the sequence controller page produces a user display apart from the user interface page.

11. The method of claim 10 wherein the user display is without variable content.

12. The method of claim 9 further comprising splitting a display area into frames including one frame that contains the sequence controller page.

13. The method of claim 9 further comprising controlling a keyboard and pointing device with the sequence controller page.

14. The method of claim 9 further comprising transferring data between the sequence controller program and the user interface page via a procedural interface or an object oriented interface.

15. An apparatus for a computer based browser to interpret user input through a user interface page that is separate from a sequence controller page comprising:
a displayed user interface page produced by a markup language;
an event handling mechanism created by executable code embedded in the user interface page that will receive user input;
a separate sequence controller page produced by a markup language;
a sequence control program created by executable code embedded in the sequence controller page that responds to the event handling mechanism;

16. The apparatus of claim 15 wherein the sequence controller page produces a user display apart from the user interface page.

17. The apparatus of claim 16 wherein the user display is without variable content.

18. The apparatus of claim 15 wherein the sequence controller page is not visible to the user.

19. The apparatus of claim 15 further comprising a browser capable of splitting a display area into frames including one frame that contains the sequence controller page.

20. The apparatus of claim 15 wherein a keyboard and pointing device, are controlled by the sequence controller.

21. The apparatus of claim 15 further comprising transferring data between the sequence controller program and the user interface page via a procedural interface or an object-oriented interface.

22. The apparatus of claim 15 embodied in a computer data signal that is propagated in a carrier wave over a network.

23. The apparatus of claim 22 wherein the network is the Internet.
